(19) United States
(12) Patent Application Publication
(10) Pub. No.: US 2018/0171138 A1
(43) Pub. Date: Jun. 21, 2018

(54) Thermoplastic Resin Composition for Laser Direct Structuring Process and Article Comprising the Same

(71) Applicant: Lotte Advanced Materials Co., Ltd., Yeosu-si (KR)

(72) Inventors: Yoo Jin JUNG, Uiwang-si (KR); Jung Ki KIM, Uiwang-si (KR); Jee Kwon PARK, Uiwang-si (KR); Sang Hyun HONG, Uiwang-si (KR)

(21) Appl. No.: 15/842,992

(22) Filed: Dec. 15, 2017

(30) Foreign Application Priority Data
Dec. 16, 2016 (KR) 10-2016-0172443

(51) Int. Cl. C08L 69/00; B29B 9/06; B29C 45/00

(52) U.S. Cl. CPC C08L 69/00; B29B 9/06; B29C 45/0001; B29K 2069/00; B29C 45/0053; B29C 2045/0079; B29C 45/0013

(57) ABSTRACT

Disclosed herein is a thermoplastic resin composition. The thermoplastic resin composition includes: a polycarbonate resin; a glycol-modified polyester resin having 1,4-cyclohexane dimethanol (CHDM) content of about 20 mol % to about 100 mol % in a diol component; inorganic fillers; and an additive for laser direct structuring (LDS additive). The thermoplastic resin composition can have good properties in terms of plating adhesion, appearance, surface hardness, and the like.

### CROSS-REFERENCE TO RELATED APPLICATION

This application claims priority under 35 USC Section 119 to and the benefit of Korean Patent Application 10-2016-0172443, filed on Dec. 16, 2016, the entire disclosure of which is incorporated herein by reference.

### FIELD

The present invention relates to a thermoplastic resin composition for laser direct structuring and a molded article including the same.

### BACKGROUND

Laser direct structuring (LDS) may be employed to deposit a metal layer on at least a portion of a surface of a molded article formed of a thermoplastic resin composition. LDS is a process performed prior to plating, wherein a region of the surface of the molded article to be plated is irradiated with laser beams to modify the region such that the region can have suitable properties for plating. For this purpose, a thermoplastic resin composition used in manufacture of the molded article is required to include an additive for LDS, which can form metal nuclei upon irradiation with laser beams. Upon receiving laser beams, the additive is decomposed to form metal nuclei. In addition, a surface of the molded article having been irradiated with laser beams becomes rougher. Due to presence of the metal nuclei and surface roughness, the laser beam-modified region can be suitable for plating.

LDS allows rapid and efficient formation of electric/electronic circuits on a three-dimensional shape of a molded article. For example, LDS may be utilized in manufacture of antennas for portable electronic devices, radio frequency identification (RFID) antennas, and the like.

Recently, with reduction in device weight and thickness, there is increasing demand for a thermoplastic resin composition having good mechanical properties and moldability (appearance characteristics). In addition, as the thickness of a micro-pattern (plating region) of a portable electronic device and the like is reduced, a plating layer is more likely to be delaminated.

Therefore, there is a need for a thermoplastic resin composition for LDS, which can have good properties in terms of plating adhesion, appearance, and surface hardness without deterioration in mechanical properties, and a molded article including the same.

### SUMMARY OF THE INVENTION

Embodiments provide a thermoplastic resin composition for laser direct structuring which can have good properties in terms of plating adhesion, appearance and/or surface hardness, and a molded article including the same.

The thermoplastic resin composition includes: a polycarbonate resin; a glycol-modified polyester resin having a 1,4-cyclohexane dimethanol (CHDM) content of about 20 mol % to 100 mol % in a diol component; inorganic fillers; and an additive for laser direct structuring (LDS additive).

The thermoplastic resin composition may include about 0.1 parts by weight to about 20 parts by weight of the LDS additive relative to about 100 parts by weight of a base resin including about 50 wt % to about 90 wt % of the polycarbonate resin, about 1 wt % to about 20 wt % of the glycol-modified polyester resin, and about 5 wt % to about 40 wt % of the inorganic fillers.

The glycol-modified polyester resin may have a CHDM content of about 35 mol % to about 100 mol % in the diol component.

The inorganic fillers may include at least one of glass fibers, talc, wollastonite, whisker, silica, mica, and basalt fiber.

The LDS additive may include at least one of a heavy metal composite oxide spinel and a copper salt.

A weight ratio of the glycol-modified polyester resin to the inorganic fillers may range from about 1:1 to about 1:4.

A weight ratio of the glycol-modified polyester resin to the LDS additive may range from about 1:1 to about 4:1.

The thermoplastic resin composition may have a peel strength of about 1.25 N/mm to about 1.60 N/mm, as measured on an injection molded specimen having a size of 5 cm×1 cm×1 mm at a peeling rate of 50 mm/min using a tensile tester after the specimen is subjected to laser direct structuring and plating to form a 35 μm thick stripe-type copper layer.

The thermoplastic resin composition may have a flow length of about 135 mm to about 170 mm, as measured on a specimen prepared by injection molding at a molding temperature of 300° C., mold temperature of 60° C., injection pressure of 50%, and injection rate of 50% using a spiral mold having a thickness of 1 mm and a width of 15 mm.

The thermoplastic resin composition may have a Rockwell hardness (R-Scale) of about 115 to about 130, as measured in accordance with ASTM D785.

The thermoplastic resin composition may have a moldability of about 10 to 50 seconds, wherein the moldability indicates a cooling time required for molding a specimen in an injection molding process conducted at a molding temperature of 300° C., mold temperature of 60° C., injection pressure of 50%, and injection rate of 50% using a spiral mold having a thickness of 1 mm and a width of 15 mm.

Other embodiments relate to a molded article formed of the thermoplastic resin composition as set forth above.

The molded article may include a metal layer on at least a portion of a surface thereof, wherein the metal layer is formed by laser direct structuring and plating.

### BRIEF DESCRIPTION OF DRAWINGS

FIG. 1 is a schematic view of a molded article according to one embodiment of the present invention.

### DETAILED DESCRIPTION

The above and other aspects, features, and advantages of the present invention will become apparent from the detailed description of the following embodiments in conjunction with the accompanying drawings. It should be understood that the present invention is not limited to the following embodiments and may be embodied in different ways by those skilled in the art without departing from the scope of the present invention. Rather, the embodiments are provided for complete disclosure and to provide thorough understanding of the present invention by those skilled in the art. The scope of the present invention should be defined only by the appended claims.

A thermoplastic resin composition according to the present invention may be used in a laser direct structuring (LDS) process and includes (A) a polycarbonate resin; (B) a glycol-modified polyester resin; (C) inorganic fillers; and (D) an additive for laser direct structuring (hereinafter, “LDS additive”).

(A) Polycarbonate Resin

According to the present invention, the polycarbonate resin may include any typical polycarbonate resin used in thermoplastic resin compositions. For example, the polycarbonate resin may be an aromatic polycarbonate resin prepared by reacting one or more diphenols (aromatic diol compounds) with a carbonate precursor such as phosgene, halogen formate, and/or carbonate diester.

Examples of the diphenols may include 4,4′-biphenol, 2,2-bis(4-hydroxyphenyl)-propane, 2,4-bis(4-hydroxyphenyl)-2-methylbutane, 1,1-bis(4-hydroxyphenyl)cyclohexane, 2,2-bis(3-chloro-4-hydroxyphenyl)propane, 2,2-bis-(3,5-dichloro-4-hydroxyphenyl)propane, 2,2-bis(3-methyl-4-hydroxyphenyl)propane, and/or 2,2-bis(3,5-dimethyl-4-hydroxyphenyl)propane, without being limited thereto. These may be used alone or as a mixture thereof. For example, the diphenols may be 2,2-bis-(4-hydroxyphenyl)propane, 2,2-bis(3,5-dichloro-4-hydroxyphenyl)propane, 2,2-bis(3-methyl-4-hydroxyphenyl)propane, 2,2-bis(3,5-dimethyl-4-hydroxyphenyl)propane, and/or 1,1-bis(4-hydroxyphenyl)cyclohexane, for example 2,2-bis-(4-hydroxyphenyl)propane, which is also referred to as bisphenol A.

Examples of the carbonate precursor may include without limitation dimethyl carbonate, diethyl carbonate, dibutyl carbonate, dicyclohexyl carbonate, diphenyl carbonate, ditolyl carbonate, bis(chlorophenyl) carbonate, m-cresyl carbonate, dinaphthyl carbonate, carbonyl chloride (phosgene), diphosgene, triphosgene, carbonyl bromide, and/or bishaloformate. These may be used alone or as a mixture thereof.

The polycarbonate resin may be a branched polycarbonate resin. For example, the polycarbonate resin may be prepared by adding a tri- or higher polyfunctional compound, for example, a tri- or higher valent phenol group-containing compound, in an amount of about 0.05 mol % to about 2 mol % based on the total number of moles of the diphenols used in polymerization.

The polycarbonate resin may be a homopolycarbonate resin, a copolycarbonate resin, or a blend thereof. In addition, the polycarbonate resin may be partly or completely replaced by an aromatic polyester-carbonate resin obtained by polymerization in the presence of an ester precursor, for example, a bifunctional carboxylic acid.

In one embodiment, the polycarbonate resin may have a weight average molecular weight (Mw) of about 10,000 g/mol to about 200,000 g/mol, for example, about 15,000 g/mol to about 40,000 g/mol, as measured by gel permeation chromatography (GPC). Within this range, the thermoplastic resin composition can have good properties in terms of impact resistance, rigidity, and/or heat resistance.

In one embodiment, the polycarbonate resin may be present in an amount of about 50 wt % to about 90 wt %, for example, about 60 wt % to about 80 wt %, based on the total weight (100 wt %) of a base resin ((A)+(B)+(C)) including the polycarbonate resin (A), the glycol-modified polyester resin (B), and the inorganic fillers (C). In some embodiments, the base resin may include the polycarbonate resin in an amount of about 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or 90 wt %. Further, according to some embodiments of the present invention, the polycarbonate resin may be present in an amount of from about any of the foregoing amounts to about any other of the foregoing amounts.

Within this range, the thermoplastic resin composition can have good properties in terms of impact resistance, rigidity, heat resistance, coating adhesion, appearance, and/or surface hardness.

(B) Glycol-Modified Polyester Resin

The glycol-modified polyester resin is a polyester resin having a 1,4-cyclohexane dimethanol (CHDM) content of about 20 mol % to about 100 mol % in a diol component and serves to improve plating adhesion, appearance (moldability) and/or surface hardness of the thermoplastic resin composition with minimal or no deterioration in rigidity, in conjunction with the LDS additive and an inorganic additive.

In one embodiment, the glycol-modified polyester resin may be prepared by polycondensation of a dicarboxylic acid component including terephthalic acid with a diol component including about 20 mol % to 100 mol %, for example about 35 mol % to 100 mol %, of CHDM and 0 wt % to about 80 wt %, for example, 0 wt % to about 65 wt %, of C₂ to C₆ alkylene glycol. If the content of the CHDM in the diol component is less than about 20 mol %, the thermoplastic resin composition can suffer from deterioration in moldability and/or surface hardness.

In some embodiments, the diol component may include CHDM in an amount of about 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100 mol %. Further, according to some embodiments of the present invention, CHDM may be present in an amount of from about any of the foregoing amounts to about any other of the foregoing amounts.

In some embodiments, the diol component may include C₂ to C₆ alkylene glycol in an amount of 0 (C₂ to C₆ alkylene glycol is not present), about 0 (C₂ to C₆ alkylene glycol is present), 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, or 80 mol %. Further, according to some embodiments of the present invention, C₂ to C₆ alkylene glycol may be present in an amount of from about any of the foregoing amounts to about any other of the foregoing amounts.

In one embodiment, the glycol-modified polyester resin may have an intrinsic viscosity of about 0.5 dl/g to about 0.8 dl/g, for example, about 0.55 dl/g to about 0.75 dl/g, as measured at 35° C. using an o-chlorophenol solution (concentration: 0.5 g/dl). Within this range, compatibility between the components of the thermoplastic resin composition can be improved and the thermoplastic resin composition can have good mechanical properties, moldability (appearance characteristics), and/or surface hardness.

In one embodiment, the glycol-modified polyester resin may be present in an amount of about 1 wt % to about 20 wt %, for example, about 5 wt % to about 15 wt %, based on the total weight (100 wt %) of the base resin (((A)+(B)+(C)) including the polycarbonate resin (A), the glycol-modified polyester resin (B), and the inorganic fillers (C). In some embodiments, the base resin may include the glycol-modified polyester resin in an amount about 1, 2, 3, 4, 5, 6, 7, 8, 9, 10, 11, 12, 13, 14, 15, 16, 17, 18, 19, or 20 wt %. Further, according to some embodiments of the present invention, the glycol-modified polyester resin may be present in an amount of from about any of the foregoing amounts to about any other of the foregoing amounts.

Within this range, the thermoplastic resin composition can have good properties in terms of moldability (appearance characteristics), surface hardness, rigidity, and/or plating adhesion.

(C) Inorganic Fillers

According to the present invention, the inorganic fillers serve to improve mechanical properties of the thermoplastic resin composition, such as impact resistance and rigidity, and may include any typical inorganic fillers other than the LDS additive. For example, the inorganic fillers may include glass fibers, talc, wollastonite, whisker, silica, mica, basalt fiber, and mixtures thereof. For example, the inorganic fillers may be glass fibers.

In one embodiment, the inorganic fillers may be glass fibers having a circular shape in cross-section and having a cross-sectional diameter of about 5 μm to about 20 μm and an as-manufactured length of about 2 mm to about 5 mm, as measured using an optical microscope, and/or glass fibers having a plate shape in cross-section and having a cross-sectional aspect ratio (major diameter/minor diameter) of about 1.5 to about 10 and an as-manufactured length of about 2 mm to about 5 mm. Within this range, the inorganic fillers can improve mechanical properties and/or surface hardness of the thermoplastic resin composition with minimal or no deterioration in other properties such as appearance characteristics.

In one embodiment, the inorganic fillers may be present in an amount of about 5 wt % to about 40 wt %, for example, about 10 wt % to about 30 wt %, based on the total weight (100 wt %) of the base resin (((A)+(B)+(C)) including the polycarbonate resin (A), the glycol-modified polyester resin (B), and the inorganic fillers (C). In some embodiments, the base resin may include the inorganic fillers in an amount about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40 wt %. Further, according to some embodiments of the present invention, the inorganic fillers may be present in an amount of from about any of the foregoing amounts to about any other of the foregoing amounts.

Within this range, the thermoplastic resin composition can have good properties in terms of impact resistance, rigidity, surface hardness, and/or appearance.

In one embodiment, a weight ratio ((B):(C)) of the glycol-modified polyester resin (B) to the inorganic fillers (C) may range from about 1:1 to about 1:4, for example about 1:1 to about 1:3. In some embodiments, the weight ratio ((B):(C)) of the glycol-modified polyester resin (B) to the inorganic fillers (C) may be about 1:1, 1:2, 1:3, or 1:4. Within this range, the thermoplastic resin composition can have good appearance characteristics and/or moldability.

(D) LDS Additive

According to the present invention, the LDS additive serves to form metal nuclei upon irradiation with laser beams and may include any typical LDS additive used in resin compositions for LDS.

In one embodiment, the LDS additive may include a heavy metal composite oxide spinel and/or a copper salt.

In one embodiment, the heavy metal composite oxide spinel may be represented by Formula 1:

AB₂O₄ [Formula 1]

wherein A is a metal cation having a valence of 2, for example, magnesium, copper, cobalt, zinc, tin, iron, manganese, nickel, and a combination thereof, and B is a metal cation having a valence of 3, for example, manganese, nickel, copper, cobalt, tin, titanium, iron, aluminum, chromium, and a combination thereof.

Examples of the LDS additive may include without limitation copper-iron spinel, magnesium-aluminum oxides, copper-chromium-manganese oxides, copper-manganese-iron oxides (oxygen may be optionally bonded to the aforementioned compounds), salts and/or oxides of copper, for example, copper oxide (I), copper oxide (II), copper phosphate, copper sulfate, and/or cuprous thiocyanate, metal complexes, chelates of copper, tin, nickel, cobalt, silver and/or palladium, copper-chromium oxide, zinc-iron oxide, cobalt-chromium oxide, cobalt-aluminum oxide, magnesium-aluminum oxide, and mixtures thereof; surface-treated products thereof; and/or oxygen-bonded products thereof. For example, the LDS additive may include copper hydroxide phosphate, copper-chromium oxide spinel, copper phosphate, copper sulfate, cuprous thiocyanate, and combinations thereof.

In one embodiment, the LDS additive may be present in an amount of about 0.1 parts by weight to about 20 parts by weight, for example, about 1 part by weight to about 15 parts by weight, relative to about 100 parts by weight of the base resin ((A)+(B)+(C)). In some embodiments, the thermoplastic resin composition may include the LDS additive in an amount about 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, or 20 parts by weight. Further, according to some embodiments of the present invention, the LDS additive may be present in an amount of from about any of the foregoing amounts to about any other of the foregoing amounts. Within this range, the thermoplastic resin composition can have good properties in terms of coating adhesion, impact resistance, rigidity, surface hardness, and/or appearance.

In one embodiment, a weight ratio ((B):(D)) of the glycol-modified polyester resin (B) to the LDS additive (D) may range from about 1:1 to about 4:1, for example, about 2:1 to about 3:1. In some embodiments, the weight ratio ((B):(D)) of the glycol-modified polyester resin (B) to the LDS additive (D) may be about 1:1, 2:1, 3:1, or 4:1. Within this range, the thermoplastic resin composition can have further improved coating adhesion.

In one embodiment, the thermoplastic resin composition may further include any typical additive commonly used in thermoplastic resin compositions without altering the effects of the present invention, as needed. Examples of the additive may include lubricants, colorants, stabilizers, antioxidants, antistatic agents, and/or flow enhancers, without being limited thereto. When the thermoplastic resin composition includes the additive, the additive may be present in an amount of 0.01 parts by weight to 20 parts by weight relative to about 100 parts by weight of the base resin.

In one embodiment, the thermoplastic resin composition may be prepared in pellet form by mixing the aforementioned components, followed by melt extrusion using a typical twin-screw extruder at about 200° C. to about 300° C., for example, about 250° C. to about 280° C.

In one embodiment, the thermoplastic resin composition may have a peel strength of about 1.25 N/mm to about 1.60 N/mm, for example, about 1.29 N/mm to about 1.55 N/mm, as measured on an injection molded specimen having a size of 5 cm×1 cm×1 mm at a peeling rate of 50 mm/min using a tensile tester after the specimen is subjected to an LDS process and a coating process to form a 35 μm thick stripe-type copper layer.

In one embodiment, the thermoplastic resin composition may have a flow length of about 135 mm to about 170 mm, for example, about 145 mm to about 170 mm, as measured on a specimen prepared by injection molding at a molding temperature of 300° C., mold temperature of 60° C., injection pressure of 50%, and injection rate of 50% using a spiral mold having a thickness of 1 mm and a width of 15 mm.

In one embodiment, the thermoplastic resin composition may have a Rockwell hardness (R-Scale) of about 115 to about 130, for example, about 116 to about 125, as measured in accordance with ASTM D785.

In one embodiment, the thermoplastic resin composition may have a moldability of about 10 to 50 seconds, wherein the moldability indicates a cooling time required for molding a specimen in an injection molding process conducted at a molding temperature of 300° C., mold temperature of 60° C., injection pressure of 50%, and injection rate of 50% using a spiral mold having a thickness of 1 mm and a width of 15 mm.

In accordance with other embodiments, a molded article is formed of the thermoplastic resin composition as set forth above. For example, the molded article may be prepared by any suitable molding method, such as injection molding, double injection molding, blowing, extruding, and/or thermoforming, using the thermoplastic resin composition. The molded article can be easily formed by a person having ordinary skill in the art to which the present invention pertains.

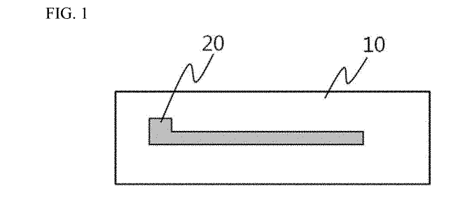

FIG. 1 is a schematic view of a molded article according to one embodiment of the present invention. It should be noted that the drawing is exaggerated in thickness of lines or size of components for descriptive convenience and clarity only. Referring to FIG. 1, a molded article 10 according to this embodiment may include a metal layer 20 on at least a portion of a surface thereof, wherein the metal layer is formed by LDS and plating. In one embodiment, the molded article 10 may be a circuit carrier used in manufacture of antennas. For example, the molded article 10 may be manufactured by fabricating a preliminary molded article 10 by injection molding or the like using the thermoplastic resin composition and irradiating a specific region (a portion to be formed with the metal layer 20) of the surface of the preliminary molded article 10 with laser beams, followed by metallization (plating) of the irradiated region to form the metal layer 20.

In one embodiment, the LDS additive included in the preliminary molded article 10 is decomposed to form metal nuclei upon irradiation with laser beams. In addition, the laser beam-irradiated region has a suitable surface roughness for plating. Here, the laser beams can have a wavelength of about 248 nm, about 308 nm, about 355 nm, about 532 nm, about 1,064 nm, or about 10,600 nm.

In one embodiment, the metallization may be performed by any typical plating process. For example, the metallization may include dipping the laser beam-irradiated preliminary molded article 10 in at least one electroless plating bath to form the metal layer 20 (electrically conductive path) on the laser beam-irradiated region of the surface of the preliminary molded article 10. Here, examples of the electroless plating bath may include a copper plating bath, a gold plating bath, a nickel plating bath, a silver plating bath, a zinc plating bath, and/or a tin plating bath.

The molded article having the metal layer formed on at least a portion of the surface thereof by LDS can be easily manufactured by a person having ordinary skill in the art to which the present invention pertains.

Next, the present invention will be described in more detail with reference to the following examples. It should be understood that these examples are provided for illustration only and are not to be in any way construed as limiting the present invention.

### EXAMPLE

Details of components used in Examples and Comparative Examples are as follows:

(A) Polycarbonate Resin

A bisphenol-A polycarbonate resin having a weight average molecular weight of 23,000 g/mol

(B) Glycol-Modified Polyester Resin

(B1) A glycol-modified polyester resin (dicarboxylic acid component: terephthalic acid, intrinsic viscosity: 0.65 dl/g) in which a diol component includes 100 mol % of 1,4-cyclohexane dimethanol (CHDM)

(B2) A glycol-modified polyester resin (dicarboxylic acid component: terephthalic acid, diol component: 40 mol % of CHDM and 60 mol % of ethylene glycol, intrinsic viscosity: 0.65 dl/g) in which a diol component includes 40 mol % of CHDM

(B3) A glycol-modified polyester resin (dicarboxylic acid component: terephthalic acid, diol component: 20 mol % of CHDM and 80 mol % of ethylene glycol, intrinsic viscosity: 0.67 dl/g) in which a diol component includes 20 mol % of CHDM

(B4) A glycol-modified polyester resin (dicarboxylic acid component: terephthalic acid, diol component: 15 mol % of CHDM and 85 mol % of ethylene glycol, intrinsic viscosity: 0.68 dl/g) in which a diol component includes 15 mol % of CHDM

(C) Inorganic Fillers

Glass fibers (CS03-183F, Owens Corning Co., Ltd.)

(D) LDS Additive

Copper hydroxide phosphate

### Examples 1 to 7 and Comparative Examples 1 to 5

The aforementioned components are mixed in amounts as listed in Table 1, followed by melt extrusion at a barrel temperature of 250° C. to 300° C. using a twin-screw extruder (L/D=36, ϕ=45 mm), thereby preparing a thermoplastic resin composition in pellet form. The prepared pellets are dried at 80° C. to 100° C. for 4 hours or more, followed by injection molding using a 6 oz. injection molding machine (molding temperature: 300° C., mold temperature: 60° C.), thereby preparing a specimen. The prepared specimen is evaluated as to the following properties and results are shown in Table 1.

Property Evaluation

(1) Plateability (plating adhesion): An injection molded specimen having a size of 5 cm×1 cm×1 mm is subjected to aging at 25° C. for 6 hours, followed by modification of a surface of the specimen in stripe form by laser direct structuring, and then a 35 μm thick stripe-type copper layer is formed on the surface of the specimen by plating (copper electroless plating), followed by measurement of peel strength (unit: N/mm) at a peeling rate of 50 mm/min using a tensile tester (Zwick GmbH & Co. KG, Ulm).

(2) Moldability (flowability): Flow length (spiral length, unit: mm) is measured on a specimen prepared by injection molding at a molding temperature of 300° C., mold temperature of 60° C., injection pressure of 50%, and injection rate of 50% using a spiral mold having a thickness of 1 mm and a width of 15 mm. A longer flow length indicates better flowability (moldability).

(3) Surface hardness: Rockwell hardness (R-scale) is measured in accordance with ASTM D785.

(4) Moldability (cooling time after injection): In an injection molding process conducted at a molding temperature of 300° C., mold temperature of 60° C., injection pressure of 50%, and injection rate of 50% using a spiral mold having a thickness of 1 mm and a width of 15 mm, a cooling time (unit: second) required for molding (completing) a specimen is measured.

TABLE 1

| | | Example | | | | | | | Comparative Example | | | | |
|---|---|---|---|---|---|---|---|---|---|---|---|---|---|
| | | 1 | 2 | 3 | 4 | 5 | 6 | 7 | 1 | 2 | 3 | 4 | 5 |
| (A) (wt %) | | 80 | 80 | 70 | 70 | 60 | 60 | 80 | 90 | 80 | 70 | 80 | 70 |
| (B) | (B1) | 10 | — | 10 | — | 10 | | — | — | — | — | — | — |
| (wt %) | (B2) | — | 10 | — | 10 | — | 10 | — | — | — | — | — | — |
| | (B3) | — | — | — | — | — | — | 10 | — | — | — | — | — |
| | (B4) | — | — | — | — | — | — | — | — | — | — | 10 | 10 |

| | | | | | | | | | | | | |
|---|---|---|---|---|---|---|---|---|---|---|---|---|
| (C) (wt %) | 10 | 10 | 20 | 20 | 30 | 30 | 10 | 10 | 20 | 30 | 10 | 20 |
| (D) (parts by weight) | 5 | 5 | 5 | 5 | 5 | 5 | 5 | 5 | 5 | 5 | 5 | 5 |
| Peel strength (N/mm) | 1.43 | 1.47 | 1.39 | 1.38 | 1.31 | 1.29 | 1.40 | 1.25 | 1.21 | 1.19 | 1.42 | 1.38 |
| Flow length (mm) | 160 | 161 | 154 | 158 | 150 | 153 | 166 | 130 | 123 | 118 | 160 | 153 |
| Rockwell hardness | 119 | 117 | 118 | 117 | 117 | 116 | 116 | 120 | 122 | 125 | 108 | 110 |
| Cooling time after | 30 | 41 | 33 | 35 | 26 | 28 | 50 | 25 | 21 | 20 | 80 | 70 |
| injection (sec) | | | | | | | | | | | | |

From the results shown in Table 1, it can be seen that the thermoplastic resin composition according to the present invention has good properties in terms of plating adhesion, moldability (flowability), surface hardness, and balance therebetween.

Conversely, the thermoplastic resin compositions of Comparative Examples 1 to 3 without the glycol-modified polyester resin according to the present invention have reduced properties for example in terms of plating adhesion and moldability, and the thermoplastic resin compositions of Comparative Examples 4 to 5 using a glycol-modified polyester resin having a CHDM content of 15 mol % in the diol component have reduced properties for example in terms of surface hardness and moldability.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A thermoplastic resin composition comprising:
a polycarbonate resin;
a glycol-modified polyester resin comprising a diol component comprising about 20 mol % to 100 mol % 1,4-cyclohexane dimethanol (CHDM);
inorganic fillers; and
an additive for laser direct structuring (LDS additive).

2. The thermoplastic resin composition according to claim 1, comprising:
about 0.1 parts by weight to about 20 parts by weight of the LDS additive relative to about 100 parts by weight of a base resin comprising about 50 wt % to about 90 wt % of the polycarbonate resin, about 1 wt % to about 20 wt % of the glycol-modified polyester resin, and about 5 wt % to about 40 wt % of the inorganic fillers.

3. The thermoplastic resin composition according to claim 1, wherein the glycol-modified polyester resin comprises a diol component comprising about 35 mol % to 100 mol % CHDM.

4. The thermoplastic resin composition according to claim 1, wherein the inorganic fillers comprise at least one of glass fibers, talc, wollastonite, whisker, silica, mica, and basalt fiber.

5. The thermoplastic resin composition according to claim 1, wherein the LDS additive comprises at least one of a heavy metal composite oxide spinel and a copper salt.

6. The thermoplastic resin composition according to claim 1, wherein a weight ratio of the glycol-modified polyester resin to the inorganic fillers ranges from about 1:1 to about 1:4.

7. The thermoplastic resin composition according to claim 1, wherein a weight ratio of the glycol-modified polyester resin to the LDS additive ranges from about 1:1 to about 4:1.

8. The thermoplastic resin composition according to claim 1, wherein the thermoplastic resin composition has a peel strength of about 1.25 N/mm to about 1.60 N/mm, as measured on an injection molded specimen having a size of 5 cm×1 cm×1 mm at a peeling rate of 50 mm/min using a tensile tester after the specimen is subjected to laser direct structuring and plating to form a 35 μm thick stripe-type copper layer.

9. The thermoplastic resin composition according to claim 1, wherein the thermoplastic resin composition has a flow length of about 135 mm to about 170 mm, as measured on a specimen prepared by injection molding at a molding temperature of 300° C., mold temperature of 60° C., injection pressure of 50%, and injection rate of 50% using a spiral mold having a thickness of 1 mm and a width of 15 mm.

10. The thermoplastic resin composition according to claim 1, wherein the thermoplastic resin composition has a Rockwell hardness (R-Scale) of about 115 to about 130, as measured in accordance with ASTM D785.

11. The thermoplastic resin composition according to claim 1, wherein the thermoplastic resin composition has a moldability of about 10 to 50 seconds, where the moldability indicates a cooling time required for molding a specimen in an injection molding process conducted at a molding temperature of 300° C., mold temperature of 60° C., injection pressure of 50%, and injection rate of 50% using a spiral mold having a thickness of 1 mm and a width of 15 mm.

12. A molded article formed of the thermoplastic resin composition according to claim 1.

13. The molded article according to claim 12, comprising a metal layer on at least a portion of a surface thereof, the metal layer being formed by laser direct structuring and plating.
